(19) United States
(12) Patent Application Publication
(10) Pub. No.: US 2003/0008410 A1
(43) Pub. Date: Jan. 9, 2003

(54) Immunoassay apparatus, kit and methods

(76) Inventor: Mark K. Hechinger, Pasadena, CA (US)

Correspondence Address: COLIN P ABRAHAMS, 5850 CANOGA AVENUE, SUITE 400, WOODLAND HILLS, CA, 91367

(21) Appl. No.: 10/023,434

(22) Filed: Dec. 12, 2001

Related U.S. Application Data
(63) Continuation-in-part of application No. 09/678,706, filed on Oct. 3, 2000, now abandoned.
Application No. 09/678,706 is a continuation-in-part of application No. 08/869,727, filed on Jun. 5, 1997, now abandoned.
Application No. 08/869,727 is a continuation-in-part of application No. 08/404,144, filed on Mar. 13, 1995, now abandoned.
(63) Continuation-in-part of application No. 09/678,707, filed on Oct. 3, 2000.
Application No. 09/678,707 is a continuation-in-part of application No. 08/868,591, filed on Jun. 4, 1997, now abandoned.
Application No. 08/868,591 is a continuation-in-part of application No. 08/404,144, filed on Mar. 13, 1995, now abandoned.
(60) Provisional application No. 60/015,873, filed on Jun. 5, 1996.
(60) Provisional application No. 60/015,873, filed on Jun. 5, 1996.

(51) Int. Cl. G01N 21/76

(52) U.S. Cl. 436/172

(57) ABSTRACT

Immunoassay methods and apparatus are provided which utilize flow cytometry, coated latex microspheres, and fluorochrome labeled antibodies, to simultaneously detect the presence and amount of several antigens or antibodies in a sample. The use of microspheres, beads, or other particles as solid supports for antigen-antibody reactions in order to detect antigens or antibodies in serum and other body fluids is particularly attractive when linked to flow cytometry. Flow cytometers have the capacity to detect particle size differences and are highly sensitive fluorescence detectors. It is practical to use beads of several different sizes, colors or shapes, each bead coated with a different protein or antibody, for the simultaneous detection of multiple analytes in a sample.

### CROSS REFERENCE TO RELATED APPLICATIONS

This application is a continuation-in-part of U.S. Ser. No. 09/678,706 filed Oct. 3, 2000 which is a continuation-in-part of U.S. Ser. No. 08/869,727 filed Jun. 5, 1997, which is a continuation-in-part of U.S. Ser. No. 08/404,144, filed Mar. 13, 1995, and which also claims the benefit of U.S. provisional application Serial No. 60/015,873, filed Jun. 5, 1996. This application is also a continuation-in-part of U.S. Ser. No. 09/678,707 filed Oct. 3, 2000 which is a continuation-in-part of U.S. Ser. No. 08/868,591 filed Jun. 4, 1997, which is a continuation-in-part of U.S. Ser. No. 08/404,144, filed Mar. 13, 1995, and which also claims the benefit of U.S. provisional application Serial No. 60/015,873, filed Jun. 5, 1996. All of the above applications are hereby incorporated by reference.

### BACKGROUND OF THE INVENTION

The present invention is directed to immunoassay methods and apparatus, and more particularly concerns an immunobead-flow cytometry method, apparatus, assay, device, system, kit, and the like for detecting and quantifying antigens or antibodies and especially adapted for the detection of autoantibodies to nuclear antigens associated with autoimmune diseases.

Typically, autoimmune testing for Systemic Lupus Erythematosis (SLE), Systemic Rheumatic Disease, rheumatoid arthritis, Sjogren's Syndrome, Progressive Systemic Sclerosis (PSS), Subacute Erythematosis, congenital complete heart block, neonatal complete heart block, neonatal lupus dermatitis, Polymyositis, Human Immunodeficiency Virus (HIV), Acquired Immunodeficiency Syndrome (AIDS), as well as other diseases has involved the use of immunological assays including hemagglutination, counter immunoelectrophoresis (CIE), immunodiffusion, Enzyme Linked Immunosorbent Assay (ELISA), and the like. For example, the Ro(SS-A) antigen having one major band at 60 kD by SDS gel electrophoresis (Silver stain) has been purified through the use of immobilized human anti-Ro(SS-A) immunoglobulins. La (SS-B) antigen has two major bands, one at 40 kD and the other at 23 kD (a degradation product) by SDS gel electrophoresis (silver stain) and has been purified through the use of immobilized human anti-La (SS-B) immunoglobulin. Smith (Sm) antigen has two major bands in the 10 and 14 kD region by SDS gel electrophoresis (silver stain) has been purified through the use of immobilized human anti-Sm (Smith) immunoglobulins. Smith (Sm/RNP) antigen has five bands, one each at 70, 40, 24, 12 and 10 kD, respectively, by SDS gel electrophoresis (silver stain) and has been purified through the use of immobilized human anti-RNP immunoglobulin. Scl-70 antigen has one major band at 68 kD by SDS gel electrophoresis (silver stain) and has been purified through the use of immobilized human anti-Scl-70 immunoglobulins. Jo-1 antigen has one major band at 50 kD by SDS gel electrophoresis (silver stain) and has been purified through the use of immobilized human anti-Jo-1 immunoglobulins. dsDNA double-stranded (native) deoxyribonucleic acid, ssDNA single-stranded DNA, whole Histones, Histone subclasses (distinct molecular fractions) tissue extracts, human antibodies, animal tissue acetone powders, sera and immunoglobulin fractions, second antibodies, anti-whole sera, whole antisera to animal proteins and to human proteins have been used in enzyme immunoassay (ELISA) for detecting or evaluating systemic rheumatic disease.

The presence of human autoantibodies to nuclear antigens, for example, antibodies against RNP/Sm, Sm, SS-A, SS-B, dsDNA and Scl-70 antigens have been diagnostic when evaluating patients with Systemic Lupus Erythematosis (SLE). Positivity may indicate more progressive disease states or simply rheumatoid arthritis. Currently, enzyme linked immunosorbent assay (ELISA) has been the assay of choice to detect these antibodies. Antibodies to Smith (Sm) antigen have been shown to occur in twenty-five to thirty percent of patients with Systemic Lupus Erythematosis. Antibodies to Sm are less commonly found in patients with other rheumatic diseases. Antibodies to ribosomal nuclear protein (nRNP) have been found in patients with Systemic Lupus Erythematosis. They are also found in sera from patients with rheumatoid arthritis, Sjogren's Syndrome (SS), Progressive Systemic Sclerosis (PSS), and Mixed Connective Tissue Disease (MCTD). Twenty to thirty percent of the patients with antibodies to Scl-70 antigen have progressive Systemic Sclerosis. Antibodies to Scl-70 are rarely found in patients with other systemic rheumatic diseases. Antibodies to Ro (SS-A) antigen are found in half of Systemic Lupus Erythematosis patients, most patients with Sjogren's Syndrome or Subacute Lupus Erythematosis and nearly all mothers of infants with congenital complete heart lock or Neonatal Lupus Dermatitis. Antibodies to the La (SS-B) antigen usually occur in twenty to thirty percent of Sjogren's Syndrome patients and with five to ten percent of Systemic Lupus Erythematosis patients. Antibodies to Jo-1 antigen are usually found in patients with polymyositis. Antibodies to Ribosomal P antigens are found to occur in five to ten percent of systemic Lupus Erythematosis patients and ninety percent of those patients will demonstrate signs of lupus psychosis. Antibodies to mitochondrial antigens are found in all primary biliary cirrhosis patients. Antibodies to histone antigens (H1, H2A, H2B, H3, H4) are found in ninety-five to one hundred percent of drug-induced Lupus Erythematosis, fifteen to twenty percent rheumatoid arthritis, and thirty percent of all patients with Systemic Lupus Erythematosis. Antibodies to cytoplasmic components of neutrophil granulocytes are present in the serum of patients with acute Wegener's granulomatosis and microscopic polyarteritis. Myeloperoxidase and proteinase 3 are the two major antigens present.

Tan and Peebles in the Manual of Clinical Immunology describe a hemagglutination technique to quantitate antibodies to Sm and RnP. Durata and Tan, using saline-soluble extracts (ENA) from rabbit thymus acetone powder at a concentration of 5 mg protein/mL, demonstrated that increased sensitivity for detecting precipitating antibodies to RNP, Sm, and SS-B could be obtained by using CIE. A modified Ouchterlony technique has been used to show precipitating antibodies to RNA (35).

There are many applications in the field of immunological monitoring in which the presence of body fluid antibodies and antigens are detected by a variety of methods. However, these assays usually measure one antibody or antigen at a time and tend to be time consuming and costly. Latex particles are commonly used clinically for detecting antibodies with agglutination as the end point. U.S. Pat. No. 5,162,863 discloses a method using flow cytometry to detect multiple antigens or antibodies with agglutination of particles combined with light scatter as the end point.

Microsphere based assays using flow cytometry have been reported by several investigators after Horan et al reported the use of polystyrene microspheres to detect serum rheumatoid factor in 1979.

The merger of bead assays with flow cytometry has been demonstrated in several clinical applications, e.g. detection of antibodies to CMV and herpes simplex; detection of antibodies to different components of the human immunodeficiency virus (HIV); detection of antibodies to several antigens of Candida albicans; detection of human anti-mouse antibody (HAMA) in transplant patients receiving OKT3; detection of circulating immune complexes and (HIV) antibody in immune complexes; and detection of two different antibodies to CEA.

Although interest has focused on the detection of antibodies and antigens in fluids, the use of other ligand systems and biological probes has been explored, e.g. competitive binding of antibiotics to DNA coated beads and detection of viruses.

Although the principals and advantages of fluorescent microsphere immunoassays have been discussed in the literature, applications in clinical lab testing have been relatively few despite the economics of time and cost inherent in this technology.

Current assays for the auto-antibodies seen in several autoimmune disorders are performed individually and require a separate kit for each antibody. A method that will simultaneously assay for several different antibodies in one tube would be of significant value.

Hence, there is a need for an improved immunoassay method and apparatus for detecting and quantifying autoantibodies to nuclear antigens associated with autoimmune diseases as well as for detecting other antigens, antibodies (to viral or bacterial proteins), cell fragments, and the like.

### SUMMARY OF THE INVENTION

In accordance with the present invention, immunoassay methods and apparatus are provided which utilize flow cytometry, coated latex microspheres, and fluorochrome labeled antibodies, to simultaneously detect the presence and amount of several antigens or antibodies in a sample.

The use of microspheres, beads, or other particles as solid supports for antigen-antibody reactions in order to detect antigens or antibodies in serum and other body fluids is particularly attractive when linked to flow cytometry. Flow cytometers have the capacity to detect particle size differences and are highly sensitive fluorescence detectors. Since most clinical laboratories have these analytical instruments, it seems appropriate to optimize the technology.

Microspheres can be sized by forward angle light scatter (FALS) or electronic volume. Used in conjunction with right angle light scatter (RALS), a flow cytometer (FCM) can distinguish between single and aggregated particles. By combining FALS and fluorescence, it is practical to use beads of several different sizes, each bead coated with a different protein, for the simultaneous detection of multiple analytes (antigens or antibodies). Microspheres can be coated with proteins passively or covalently depending on their chemical makeup.

Additionally, either discriminating by size or color, an assay (one bead) can be added as a module to create bits which can be defined (e.g. one bead/test and a user adds specific beads depending on how many tests are ordered).

The strengths of this type of assay are: 1) the ability to simultaneously, but discretely, analyze multiple analytes; 2) the simplicity of binding proteins to microspheres; 3) the ability of flow cytometry (FCM) to detect small particle size differences; and 4) the exquisite sensitivity of FCM as a detector of different wavelengths of fluorescence, simultaneously. Available auto-sampling systems make it even more appealing in this regard. The capacity to simultaneously detect multiple analytes in one tube in a immunoassay system suggests that immunoassays and biological probe assays may ultimately mimic multichannel chemistry analyzers with all of their benefits.

In accordance with one embodiment of the present invention, highly purified Scl-70, RNP/SM, SM, SS-A, SS-B and dsDNA antigens are bound to 3, 4, 5, 6, 7 and 8 μm latex beads, respectively and stabilized for extended shelf life. Diluted patient serum is place into test tubes containing a mixture of six antigen coated beads and incubated. If an antibody is present for a specific antigen, it will bind to that specific bead. No washing is performed between incubations. A second incubation with goat anti-human IgG, conjugated with a fluorochrome such as fluorescein isothiocyanate (FITC), is carried out. This conjugate will bind immunologically to the anti-antigen IgG of the antigen-antibody complex, forming a “sandwich” consisting of bead—antigen—1° human antibody—2° antiIg antibody—FITC (FIG. 1).

The fluorescence intensity is based on the avidity of the bead/antibody/conjugate binding. The samples are analyzed using flow cytometers having laser excitation wavelengths of 488 nm. Emission wavelengths of 514 nm are detected by photomultipliers (PMTS) which convert the fluorescent analog signals into two parameter histograms expressing forward light scatter (Y-axis) versus fluorescence intensity (X-axis, FIG. 2). Other laser wavelengths may be used depending on impregnation of dye into the bead or the type fluorescence used on the secondary (indicator) antibody.

In accordance with another embodiment of the invention, a fluorescent immuno-bead assay (FIBA) kit is used in conjunction with flow cytometry (FCM) for the simultaneous detection of the antinuclear antibodies to RNP (ribonucleo-protein) seen in mixed connective tissue disease, systemic lupus erythematosis (SLE), Sjogren's syndrome, scleroderma and polymyositis; Sm (Smith antigen) in SLE; SS-A in Sjogren's syndrome and SLE; SS-B in Sjogren's syndrome and SLE; Scl-70 in scleroderma; and dsDNA as seen in multiple variants of SLE. These antibodies are commonly encountered in the so-called rheumatic diseases. Other antigens are seen in these classes and can be used in specific diagnostic cases.

By attaching each of these antigens to different sized latex beads, the presence of antibodies to one or more of these antigens can be rapidly detected and semi-quantitate. Instead of the six or more separate assays currently required, one assay involving six or more beads of different sizes in one tube provides the information needed. The cost savings in terms of materials, supplies, and technician time are estimated to be 60-70%. This can be further enhanced by utilizing robotic auto-sampling devices currently available or being developed for flow cytometry, for example, the Coulter XL with an auto-sampler.

The principal object of the present invention is the provision of an immunobead-flow cytometry assay for simultaneously detecting a plurality of antigens or antibodies in a sample.

Another object of the present invention is the provision of a multiple parameter latex bead suspension and flow cytometry to simultaneously detect the presence of a plurality of autoantibodies to nuclear antigens associated with autoimmune disease.

Yet another object of the present invention is the provision of a no-wash fluorescent immunobead assay.

Another more particular object of the present invention is a commercial assay kit designed to simultaneously detect several anti-nuclear antibodies in patient sera utilizing antigen coated microspheres of different sizes. Binding of antibody to spheres is detected by fluorescenated labeled anti-human IgG and flow cytometry. Each individual antibody is detected because of binding to a different sized sphere which is determined by light scatter.

Another object of the present invention is to substitute the “no-wash” system found for the anti-ENA detection, for viral and bacterial antigens.

In another aspect, the invention comprises the ability to modulate the total (assays) being evaluated by selectively adding different beads, whether distinguished by size or fluorescence, into the test tube. This makes it conceivable to have beads in separate vials and dropping them into one tube while adding a predetermined amount of sample.

Future applications are essentially unlimited because the immunoassay of the present invention can be applied to any ligand binding system and the number of simultaneous assays can be expanded by the use of combinations of fluorophores and multiple microsphere sizes.

Other objects and further scope of the applicability of the present invention will become apparent from the detailed description to follow, taken in conjunction with the accompanying drawings wherein like parts are designated by like reference numerals.

### BRIEF DESCRIPTION OF DRAWINGS

FIG. 1 is a schematic representation of an exemplary immunological structure of the bead-antigen-antibody indicator complex,

FIG. 2 is a schematic illustration of the flow cytometer histogram of forward angle light scatter (size) versus fluorescence on a positive control sample in a multiple bead system,

FIG. 3 is a schematic representation of a flow cytometer histogram of a negative control in a multiple bead system,

FIG. 4 is a schematic illustration of a flow cytometer histogram of the size characteristics of latex beads when run on a flow cytometer,

FIG. 5, is a representation of a flow cytometer cytogram of the size and complexity distribution as is seen with a patient sample of beads coated with antigen and analyzed in a flow cytometer,

FIG. 6 is an illustration of a flow cytometer histogram coated beads incubated with a negative control sample,

FIG. 7 is a representation of a flow cytometer histogram of a positive sample in which antibody to Scl-70 is present, but no antibodies to the other antigens are present,

FIG. 8 is an illustration of a three dimensional flow cytometer histogram of the three parameters of bead size, first fluorescence color (F11), and second fluorescence color (F12),

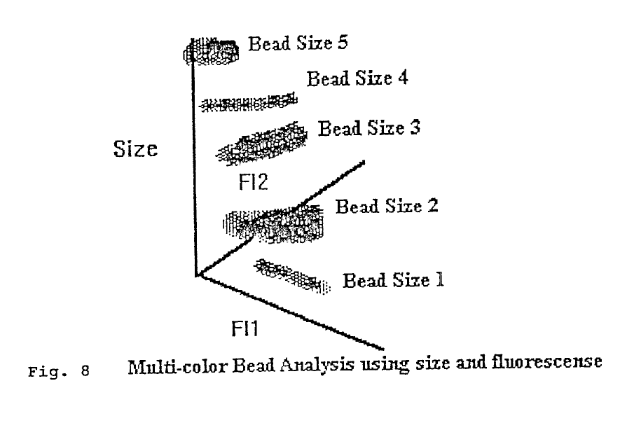

FIG. 9 is a schematic representation of a two dimensional flow cytometer histogram of different sized beads labeled with different fluorochromes.

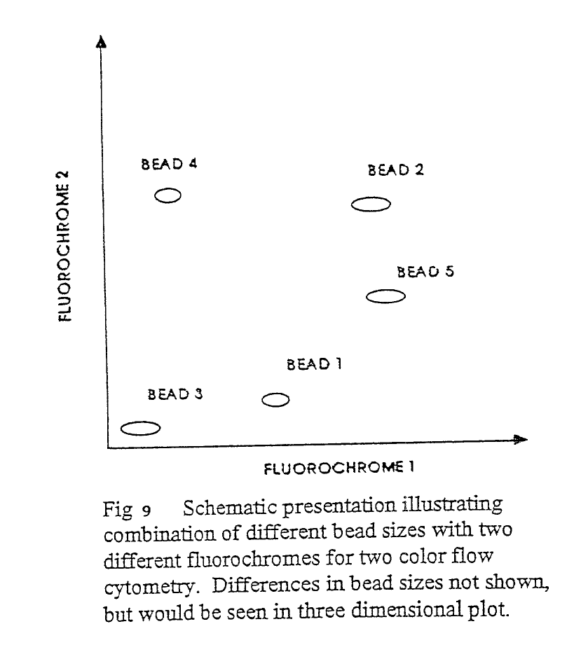

### DETAILED DESCRIPTION OF THE PREFERRED EMBODIMENTS

In accordance with an exemplary embodiment of the present invention, antigen coated latex surfaces, anti-nuclear antibodies, fluorescenated antibodies against such anti-nuclear antibodies, and flow cytometry are combined to provide multiparameter devices for the detection of a plurality of antigens in a single tube.

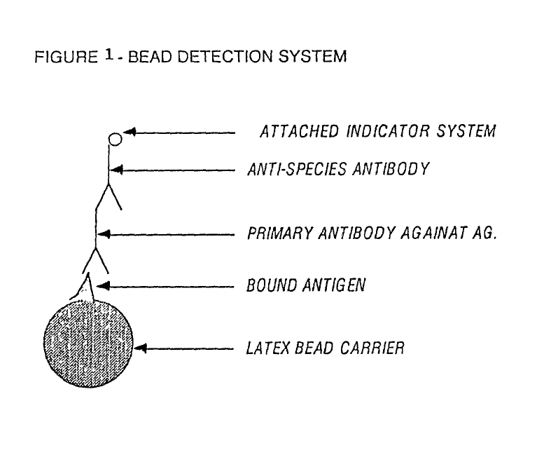

One basic principle of the present invention is to conjugate antigens or antibodies to the exterior of latex microspheres (beads) of different sizes. The coated microspheres are used to detect the appropriate specific antibodies or antigens simultaneously in one tube. The ability to detect multiple analytes in one reaction tube eliminates the variability often seen in results arising from separate assays. Procedurally, latex beads are coated with specific antigens or antibodies. These beads vary in size and may also contain (such as being impregnated with) fluorescent dyes e.g. FITC, PE, etc. One or more of these precoated beads are then incubated with the sample (serum, body fluid) solution. If an antibody-antigen complex has been formed, a 2° incubator fluorochrome labeled antibody will bind to the appropriate bead (FIG. 1).

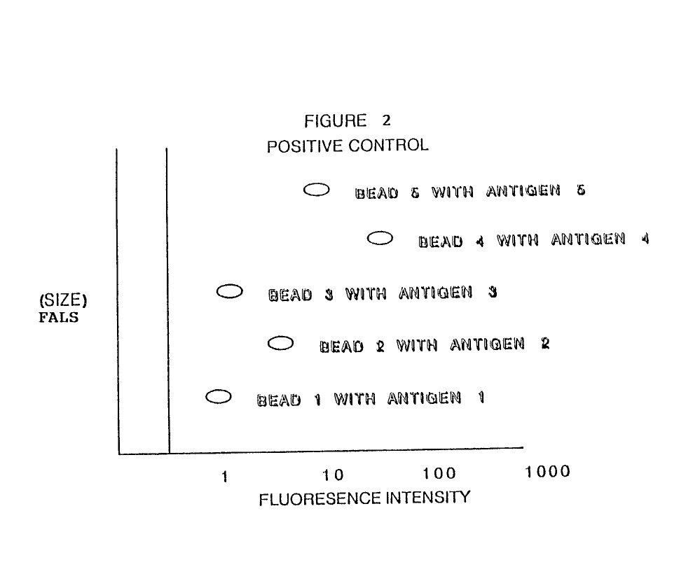

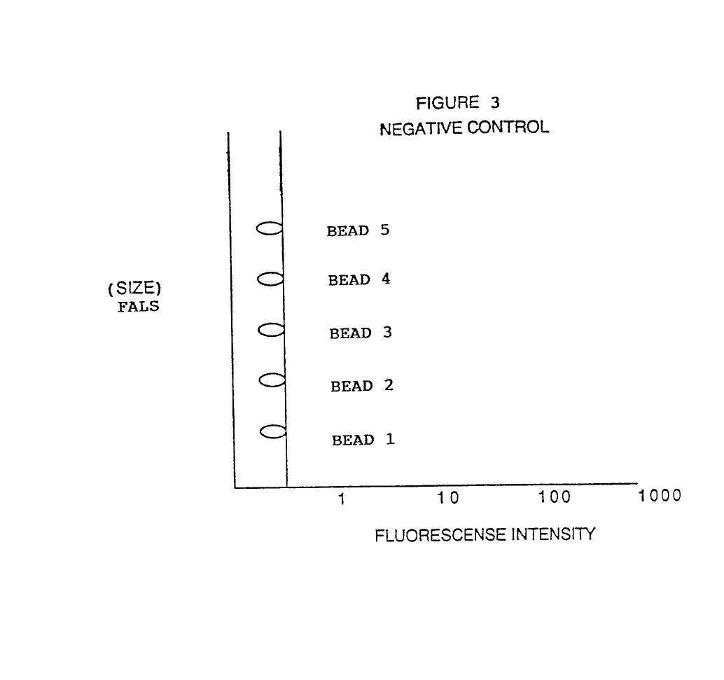

The beads may then be analyzed using forward angle light scatter to discriminate the different sized beads, each bound to a different antigen or antibody, and analyzed to detect fluorescence with a flow cytometer, or distinguished by fluorescent properties if impregnated. The solution containing beads is passed through a series of tubes until it reaches the optical quartz cell of the flow cytometer. Because of the laminar flow of sheath fluid, single particle analysis is achieved. The signal is converted from analog to a digital display representing the size of the spheres and fluorescence of each (FIG. 2). Controls are used to adjust for the fluorescence background created by electronic and particle noise (FIG. 3). A forward scatter (size) adjustment of the multiple sized bead antigen or antibody complexes is necessary in order to semi-quantitate or quantitate the relative concentration of antigen or antibody on the bead surface through single screen, visual distribution. At times, this can be accomplished by adjusting the PMT's to set a particular parameter at a specific mean channel of size and/or fluorescence. Techniques such as these help standardize the assay. As seen in FIG. 3, a fluorescent threshold (x-axis) is established below which fluorescence values are considered negative. Upon addition of a “positive” sample, (containing appropriate antibody or antigen), the reaction between the fluorochrome labeled indicator antibodies and antigen or antibody bead complex, amplifies the fluorescence signals detected by the flow cytometer (FIG. 2). Thus, the definition of “positivity” in this system is relative to the negative control (background) and can easily be interpreted.

“Positivity” of the bead can be measured in many ways. As an index, standardization can be achieved by using known quantitate positive controls. One such way may be to divide the mean channel fluorescence of the patient or positive control by the mean of the same bead on the “negative” or normal control.

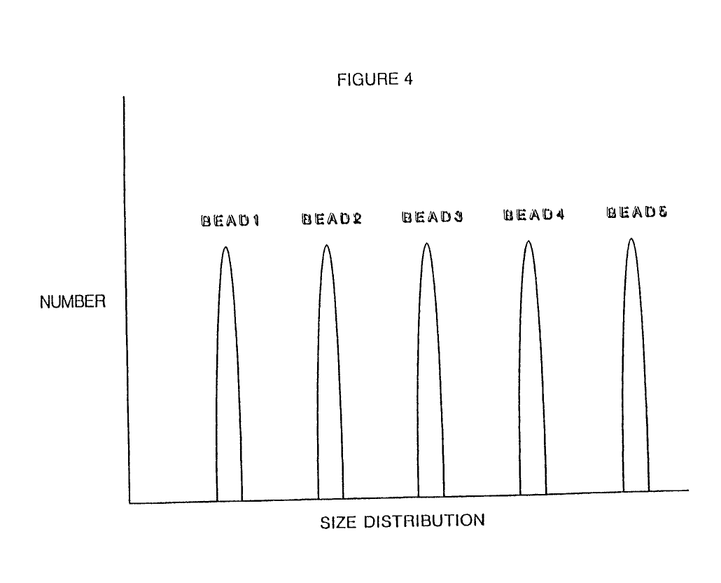

Multiple antibodies or antigens can readily be displayed and quantitative values obtained in a single two-dimensional histogram. Similarly, additional bead systems can be combined within the size distinguishing capabilities of the flow cytometer and the sizes available from vendors providing latex particles (FIG. 4). As seen in FIG. 1, the multiple antigen or antibody coated bead system incorporates specific anti-species specific 2° antibodies, labeled with fluorochromes (e.g., FITC, PE), to detect the presence of antigen-antibody complexes on the beads. All other antibodies non-specifically bound to the latex surface are either protein blocked or ignored by the indicator antibody.

The present invention uses the principles of flow cytometry and light scatter to detect different sizes of latex particles with fluorescence as the endpoint. Multiple antigens or antibodies in body fluids are detected simultaneously in a single tube because each specific antibody or antigen is differentiated by the size of the bead it is bound to. This invention differs from the procedure disclosed in U.S. Pat. No. 5,162,863 in that the latter “measures the presence of the amount of a plurality of kinds of particular antigens or antibodies in a specimen at a time by a simple construction without the use of fluorescence” and “it has been difficult to reliably discriminate between kinds of the particles from the fluorescence.”

The invention allows similarly manufactured beads which may be combined in clinically appropriate combinations, or individually packaged, to be used to create multiple assay systems. Further, a mix and match chart of information particulars which indicates the proper quantities of bead suspensions, whether mixed or single bead suspensions, may form part of a kit including the assy of the invention. The assay may be a “no wash” assay.

The assay may be completed and read on a flow cytometer. However, as part of the mix and match concept, beads could be added after the evaluation to rule out other disease states. For example, other beads could be added to the assay after the test is complete if all the tested beads are negative. Thus, the invention can in this way substantially save sample supplies, the time taken to carry out the tests, as well as reagents.

Advantages of the present invention include:

1. Because of varying sizes and dyes of microspheres, multiple antibodies or antigens can be detected and quantitate simultaneously in a single tube.

2. Specific antibodies/antigens can much more easily be detected when bound to latex bead surfaces due to the separation of one antigen/antibody from the other.

3. Because of the sensitivity of fluorescence based flow cytometry this assay tends to be capable of detecting lower levels of antibodies/antigens than other conventional assay methods e.g. EIA, ELISA, agglutination etc.

4. Because of a relatively unlimited range of bead sizes, other bead physical characteristics, fluorochromes and probes this invention offers great flexibility.

5. Single tube analysis facilitates the utilization of “batch-mode” processing and automation.

6. The present assay system can be used in screening, semi-quantitative or quantitative methods.

7. Almost any flow cytometer may be utilized for this method.

8. Minimal volumes of sample are necessary in order to run multiple assays.

9. Materials bound to the latex bead surface may be antigens, antibodies, chemicals, microorganisms, cell components, and other substances capable of binding specifically to an appropriate ligand, including DNA and RNA for in situ hybridization.

10. It is possible to mix and match bead sizes and/or different fluorochrome impregnated dyes.

Kits

Various types and forms of kits, some of which are described hereunder, can be used in accordance with the invention.

1. Anti-ENA Kit—No Wash System

Antigens may include dsDNA (10 u bead), SS-B (8 u bead), SS-A (7 u bead), Sm (6 u bead), RnP/Sm (5 u bead), and Scl-70 (3 u bead).

Steps for Kit:

a. Predilute patient serum 1:100 with diluent.

b. Remove bead mixture from refrigerator and let sit for 15 minutes.

c. Invert bottle containing bead slurry until mixture is evenly dispursed.

d. Add 600 uL of bead mixture to each tube labeled control (s) and patient(s).

e. Add 15 uL of diluted patient serum to each of the appropriate tubes.

f. Vortex and incubate, at room temperature, for 30 minutes.

g. Add 50 uL of Kit Conjugate to each tube.

h. Vortex and incubate, at room temperature and in the dark, for 30 minutes.

i. Prepare calibration bead (s) by adding on drop of beads to 1 mL. of sample diluent.

j. Align flow cytometer with alignment beads as indicated by the package insert.

k. Analyze control and patient samples on flow cytometer.

l. Report results.

2. Anti-dsDNA Kit—No Wash System

An antigen may be dsDNA on 10 u bead only (as above); the same procedure may be used, as described.

3. Anti-Viral Antibody Kit(s)

a. Examples: Hepatitis B, HIV, HepB core antibody, CMV, EBV, etc.

b. Kit may detect both Acute (IgM antibodies) and convalescent (IgG) antibodies through the use of different fluorescently conjugated antibodies or beads impregnated with different color.

c. Bacterial antigens may be similarly used.

4. Anti-Cardiolipin Antibody Kit—Any Size or Color Bead Detection System.

5. Other Rheumatological Antigen (e.g. histones, Jo-1, PM-1, ssDNA etc.), Viral, Recombinant Protein or Bacterial Antigen (e.g. E. coli, etc.)

Technical

Dilution of Serum Samples

a. Beads tend to work well only with serum and not plasma.

b. Indicator conjugate, on flow, needs to be diluted (if necessary) with a protein buffer (e.g. 1-10% BSA in PBS with azide) to decrease the amount of non-specific binding, or background.

c. Patient samples should also be diluted with the same material as in “b” above, if necessary.

d. Carbonate buffer is stabilizing factor for beads.

e. Surfactant in stock bead solution needs to be at a certain specific concentration (%) of total, otherwise, antigen will not attach.

Some Applications

a. Bead products may be created to where laboratorians can select from a series of products (with different bead sizes and/or impregnated colors); each may have a different assay property (antigen/antibody) and mix together in the same reaction vessel. The advantages of this application include: 1) using the same sample, 2) reaction time is the same for multiple assays, 3) result time quickens, 4) it is cost effective, 5) test is able to use smaller amounts of sample for multiple assays.

b. Beads may be added to the assayed tubes after a run on the flow cytometer to determine if another component can possibly be detected when the first run shows that those initial selections generated a negative result.

Example: Tech A runs a six bead assay on the flow cytometer. All the results were negative. Tech B takes the same tube and adds a 7^{th} bead to the test tube, mixes and incubates again. This time the 7bead (assay) is positive.

c. Positive Control for rare events—Beads are added to the actual reaction vessel, the control bead(s) are artificial antigens/antibody substrates used to monitor test specificity/sensitivity, or just to determine whether the assay works with the antigens/antibodies it is supposed to detect with the given conjugated indicator antibody.

Example: CD34 is the pluripotential stem cell marker which is a rare event on normal human mononuclear cells. Cancer therapies, at times, depend on the amount of these CD34 + stem cells in the blood or bone marrow for transplantation purposes, after chemotherapy or radiation. Once injected into the cancer patient, they should find their way into the bone marrow, grow and repopulate the patient with normal cells. Therefore, CD34+ cells need to be quantitated prior to infusion in order to determine the optimal “harvest” time. Unfortunately, when using flow cytometry, there are decreasing numbers of commercially available positive control cells used to validate the integrity of the fluorescenated antibodies used to detect these cells. These positive control beads, not unlike the platelet control beads, could be added to the reaction tubes containing the patients bone marrow or blood. In this way, the purified CD34 antigen, attached to the bead, would allow the anti-CD34 antibody to bind to its surface as well as, if present, any stem cells found in the sample. Various levels of positivity could be predetermined for the bead as an acceptable criteria for the quality control of the antibody.

Other bead controls may include blood-type antigens, rare event white cell antigens, other chemicals, receptors, proteins, therapeutic drugs, etc.

### EXAMPLES

1. Modularity Kit—Several assays on sample have been requested by the physician. They include both viral and bacterial antibody screens. The following would be an example of this kit:

a. 3 u—Bead containing Hepatitis B antigen

b. 4 u—Bead containing HIV I/II antigen

c. 5 u—Bead containing E. coli antigen

d. 6 u—Bead containing Streptococcus antigen

e. 7 u—Bead containing Staphylococcus antigen

f. 8 u—Bead containing HCV antigen

Kit procedure would be the same as in the anti-ENA kit.

2. Based on above, but mixing the anti-ENA kit with either bacterial or viral antibodies or antigens.

3. Table of mix and match kit to be a package insert with individual beads. Each bead would have been titered to be part of a complete assay with at least one bead/assay.

4. Detection of Acute (IgM) or Convalescent (IgG) Antibodies—In any viral or bacterial kit, these states of infection could be important to treatment. The detection process used for the bead-based assay could be either using anti-human Ig's labeled with different fluorchromes, or having beads impregnated with different fluorescent dyes for the same antigen using the same indicator fluorochrome for the IgG or IgM. For example, if testing for Hepatitis, two beads, with a red and green dye impregnated into the latex, would both be coated with the same Hepatitis antigen, however, the anti-human IgG or IgM detector antibodies would both be conjugated with FITC. Thus, the IgG bead would be detected by a red bead channel and the IgM by a green bead channel and then each individually evaluated for positivity on a separate green PMT.

5. No Wash Concept with Modularity Construct

6. Other Viral and Bacterial Assays

7. Reuse Testing Material to Add New Assay—This concept allows for the user to add another assay to the test tube after it has been analyzed. For example, if the bead results are all negative, another assay may prove positive. Sample may also be limited and, therefore, this conserves time, sample and reagents.

8. Packaging—Beads maybe packaged a one, two, or more individual assays, but allowed to be as modular components (as mentioned above).

### Example 1

No Wash Detection System

In accordance with one example of the present invention, six distinct latex beads coated with a unique antigen are incubated with pre-diluted human serum and then labeled with goat anti-human FITC labeled antibodies. Positivity is distinguished or semi-quantitate using a blank or isotopic control as the negative standard. Flow scatter (forward angle light scatter, FALS, size) versus green fluorescence are used to detect positivity.

Purified antigens, positive control sera, human antibodies, monospecific donor plasma, anti-human antibodies, etc. for autoimmune testing are commercially available. For example, affinity purified, highly immunospecific antigens such as Ro(SS-A), La(SS-B), Sm(Smith), Sm/RNP, Scl-70, and dsDNA as well as purified whole histones and histone subclasses (distinct molecular fractions) are commercially available. Also available are positive control sera for autoimmune testing, human antibodies against Ro(SS-A), La(SS-B), Sm, RNP, Scl-70, Jo-1, PM-1, monospecific donor plasma against Cardiolipin, dsDNA, Jo-1, Mitochondrial, PCNA, RM-1, Po, RNP, Scl-70, Sm, Ro(SS-A), La(SS-B), and thyroid Microsomal, animal tissue acetone powders, animal sera and immunoglobulin fractions (whole serum, gamma fractions, purified IgG), animal second antibodies (whole antisera, IgG fractions, affinity purified), anti-whole sera, mouse antisera, and whole antisera to selected animal and human proteins.

Materials—Examples

3 μm particle sized latex bead, Duke Scientific, Cat #4203A

4 μm particle sized latex bead, Duke Scientific, Cat #4204A

5 μm particle sized latex bead, Duke Scientific, Cat #4205A

6 μm particle sized latex bead, Duke Scientific, Cat # 4206A

7 μm particle sized latex bead, Duke Scientific, Cat # 4207A

8 μm particle sized latex bead, Duke Scientific, Cat # 4208A

Sm/RNP Complex antigen, Immunovision, Cat #SCR-3000

Sm antigen, 1000 units, Immunovision, Cat #SM-3000

SS-A (Ro) antigen, 100 units, Immunovision, Cat # SSA-3000

SS-B (La) antigen, 100 units, Immunovision, Cat #SSB-3000

Scl-70 antigen, 1000 units, Immunovision, Cat # SCL-3000

dsDNA antigen, Immunovision,

Anti-RNP, Lypholyzed, Immunovision, Cat #HRN-0100

Anti-Sm, Lypholyzed, Immunovision, Cat #HSM-0100

Anti-SS-A (Ro) Lypholyzed, Immunovision, Cat #HSA-0100

Anti-SSB (LA), Lypholyzed, Immunovision, Cat # HSC-0100

Anti-Scl-70, Lypholyzed, Immunovision, Cat # HSC-0100

anti-dsDNA,

Goat anti-human IgG F(ab′)²-FITC, Tago, Inc., Cat#4200

Sodium Carbonate, Sigma Chemical, Cat # S-6139

Sodium Bicarbonate, Baker Chemical, Cat # 3506-1

Albumin, bovine, Sigma Chemical, Cat #A-7888

200 μl adjustable pipette

pipette tips

10 mL pipettes

Centrifuge

12×75 mL polystyrene test tubes

13 mm caps

flow cytometer

Reagents

Carbonate Buffer, pH 9.6

Add 1.5 g of sodium carbonate and 0.8 g of sodium bicarbonate to 500 mL of distilled water. Mix for 5-10 minutes or until all crystals are dissolved. Adjust pH to 9.6 using 2N NaOH. Store at 4-8° C. Buffer only to be used for less than 48 hours after preparation. For antigen coating only. 0.03% albumin, bovine in PBS. Mix 0.03 g of bovine albumin in 100 mL of carbonate buffer. Mix thoroughly. Store at 4-8° C. for one month.

Procedure

1. Determine the amount of latex bead suspension (e.g. # of drop w/mL carbonate buffer) needed to achieve an event count of 900-1000 beads/second on the flow cytometer.

2. Titer antigen (Ag) to appropriate μg/mL and use concentration deemed optimal for maximum mean channel and fluorescence.

3. Add antigen to each respective tube: (μg) (quantities may differ from lot to lot)

| Antigen (size bead) | Drops/mL Buffer | Ag/mL Buffer |
|---|---|---|
| dsDNA (8 μm) | 10 | 10 |
| RNP (4 μm) | 3 | 30 |
| Sm (5 μm) | 3 | 10 |
| SS-A (6 μm) | 6 | 15 |
| SS-B (7 μm) | 6 | 15 |
| Scl-70 (3 μm) | 10 | 10 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of 0.3% albumin in carbonate buffer per mL original volume.

8. Gently vortex.

9. Repeat steps 5 and 6.

10. Add 1 mL of carbonate buffer per original milliliters of antigen/bead solution (further dilution may be accomplished based on bead counts and second analysis—higher counts mean the possibility of more dilution).

11. Add 100 uL of each antigen/bead mixture to all reaction tubes.

12. Pre-dilute positive, negative and patient serum 1:100 in buffer solution with protein.

13. Add 15 μL of each pre-diluted serum to appropriately labeled tube.

14. Gently vortex and incubate for 15 minutes at room temperature.

15. Add 50 μL of Goat anti-human IgG F(ab′)²-FITC 1:20 (NOTE: dilution may slightly vary from lot to lot. Titer all new lots).

16. Gently vortex and incubate 15 minutes at room temperature.

17. Add 0.5 mL of carbonate buffer and vortex.

18. Read on flow cytometer.

In a variation of this example, all components may be mixed in one bottle.

### Example 2

“No Wash” Detection System—Pre-Mix Bead Suspension

In accordance with another example of the present invention, an immunobead-flow cytometry method for simultaneously detecting a plurality of antigens is as follows.

Procedure

1. Determine the amount of latex bead suspension (e.g. # of drop w/mL carbonate buffer) needed to achieve an event count of at least 500 beads/second on the flow cytometers.

2. Titer antigen (Ag) to appropriate pg/mL and use concentration deemed optimal for maximum mean channel and fluorescence.

3. Add antigen to each respective tube: (μg)

| Antigen (size bead) | Drops/mL Buffer | Ag/mL Buffer |
|---|---|---|
| RNP (0.25 μm) | 3 | 30 |
| Sm (0.50 μm) | 3 | 10 |
| SS-A (0.75 μm) | 6 | 15 |
| SS-B (1.0 μm) | 6 | 15 |
| Scl-70 (1.25 μm) | 10 | 10 |
| dsDNA (3 μm) | 10 | 5 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of 0.3% albumin in carbonate buffer per mL original volume.

8. Gently vortex. 9. Repeat steps 5 and 6

10. Add 1 mL of carbonate buffer per original milliliters of antigen/bead solution (final dilution may vary).

11. Mix all beads together, vortex.

12. Add 600 μL of the pre-mixed 6 antigen-coated bead suspension.

13. Add 15 μL of a 1:100 dilution of patient or control serum diluted in a buffer solution with protein.

14. Gently vortex and incubate for 15 minutes at room temperature.

15. Make a 1:20 dilution of Goat anti-human F(ab′)² IgG-FITC in buffer with protein.

16. Add 50 μL of diluted conjugate to the bead suspension.

17. Incubate for 15 minutes at room temperature in the dark.

18. Add 1 mL of PBS.

19. Analyze on flow cytometer.

Cytometer adjustments of fluorescent gains will change, therefore, it is recommended that a blank and normal control be run as reference material. Conjugate titers may vary, serial dilutions must be made on all new lots.

In a variation of this example, the same mixed beads can be used, but with different sizes. The sizes may be as stated in example 1. Further, only one bead may be used, or two or three beads may be mixed (eg. SSA/B, RnP/Sm, ds DNA only).

### Example 3

No Wash Detection System—Modular System 6 Antigens

In accordance with yet another example of the assay of the present invention the method follows.

Procedure

1. Determine the amount of latex bead suspension (e.g. # of drop w/mL carbonate buffer) needed to achieve an event count of 900-1000 beads/second on the flow cytometer.

2. Titer antigen (Ag) to appropriate μg/mL and use concentration deemed optimal for maximum mean channel and fluorescence.

3. Add antigen to each respective tube: (μg)

| Antigen (size bead) | Drops/mL Buffer* | Ag/mL Buffer* |
|---|---|---|
| RNP (660 μm) | 3 | 30 |
| Sm (680 μm) | 3 | 10 |
| SS-A (700 μm) | 6 | 15 |
| SS-B (720 μm) | 6 | 15 |
| Scl-70 (740 μm) | 10 | 10 |
| dsDNA (840 μm) | 10 | 5 |

*value may vary from lot to lot.

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of 0.3% albumin in carbonate buffer per mL original volume.

8. Gently vortex.

9. Repeat steps 5 and 6.

Add 1 mL of carbonate buffer per original milliliters of antigen/bead solution. Mix RNP/Sm and Sm beads together. Mix SS-A/SS-B beads together. Keep Scl-70 and dsDNA beads as separate assays.

10. Add 100 uL of each antigen/bead mixtures to all reaction tubes (e.g. 4 tubes per sample).

11. Dilute positive, negative and patient serum 1:100 in Buffer with protein.

12. Add 15 μL of each serum diluted to appropriately labeled tube.

13. Vortex gently and incubate for 15 minutes at room temperature.

14. Add 50 μL of Goat anti-human IgG F(ab′)²-FITC 1:20 (NOTE: dilution may slightly vary from lot to lot. Titer all new lots).

15. Gently vortex and incubate 15 minutes at room temperature.

16. Read on flow cytometer.

In a variation, repeat as for Example 3 but drop in dsDNA to each tube labeled RNP/SM/SM, SSA/B, Scl-70 and change volumes of sample accordingly.

### Example 4

No Wash Detection System—Multiple Analytes; Non-ENA

In accordance with still another example of the present invention the assay is as follows.

Procedure

5 1. Determine the amount of latex bead suspension (e.g. # of drop w/mL carbonate buffer) needed to achieve an event count of 900-1000 beads/second on the flow cytometer.

2. Titer antigen (Ag) to appropriate pg/mL and use concentration deemed optimal for maximum mean channel and fluorescence.

3. Add antigen to each respective tube: (μg)

| Antigen (size bead) | Drops/mL Buffer | Ag/mL Buffer |
|---|---|---|
| Streptococcus Ag (3 μm) | 3 | 30 |
| Histone (4 μm) | 3 | 30 |
| HIV (5 μm) | 3 | 10 |
| Hepatitis Bs Ag (6 μm) | 6 | 15 |
| Centromere (7 μm) | 6 | 15 |
| Candida (10 μm) | 10 | 10 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of 0.3% albumin in carbonate buffer per mL original volume.

8. Gently vortex.

9. Repeat steps 5 and 6.

10. Add 1 uL of carbonate buffer per original milliliters of antigen/bead solution.

11. Add 100 mL of each antigen/bead mixture to all reaction tubes.

12. Dilute positive, negative and patient serum 1:100 in buffer with protein.

13. Add 15 μL of each serum diluted to appropriately labeled tube.

14. Vortex gently and incubate for 15 minutes at room temperature

15. Add 50 μL of Goat anti-human IgG F(ab′)²-FITC 1:20 (NOTE: dilution may slightly vary from lot to lot. Titer all new lots.

16. Gently vortex and incubate 15 minutes at room temperature.

17. Read on flow cytometer.

### Example 5

No Wash Detection System—Other Rheumatological Antigens

In accordance with another example of the present invention the multiple parameter bead assay is as follows.

Procedure

1. Determine the amount of latex bead suspension (e.g. # of drop w/mL carbonate buffer) needed to achieve an event count of 900-1000 beads/second on the flow cytometer.

2. Titer antigen (Ag) to appropriate μg/mL and use concentration deemed optimal for maximum mean channel and fluorescence.

3. Add antigen to each respective tube: (μg)

| Antigen (size bead) | Drops/mL Buffer | Ag/mL Buffer |
|---|---|---|
| ss-DNA (4 μm) | 3 | 30 |
| Ribosomal P (5 μm) | 3 | 10 |
| Mitochondria (6 μm) | 6 | 15 |
| Histone H1 (7 μm) | 6 | 15 |
| Histone H2A (10 μm) | 10 | 10 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of 0.3% albumin in carbonate buffer per mL original volume.

8. Gently vortex.

9. Repeat steps 5 and 6.

10. Add 1 uL of carbonate buffer per original milliliters of antigen/bead solution (value may vary).

11. Add 100 mL of each antigen/bead mixture to all reaction tubes.

12. Dilute positive, negative and patient serum 1:100 in Buffer solution with protein.

13. Add 15 μL of each serum diluted to appropriately labeled tube.

14. Vortex gently and incubate for 15 minutes at room temperature.

15. Add 50 μL of Goat anti-human IgG F(ab′)²-FITC 1:20 (NOTE: dilution may slightly vary from lot to lot. Titer all new lots).

16. Gently vortex and incubate 15 minutes at room temperature.

17. Read on flow cytometer.

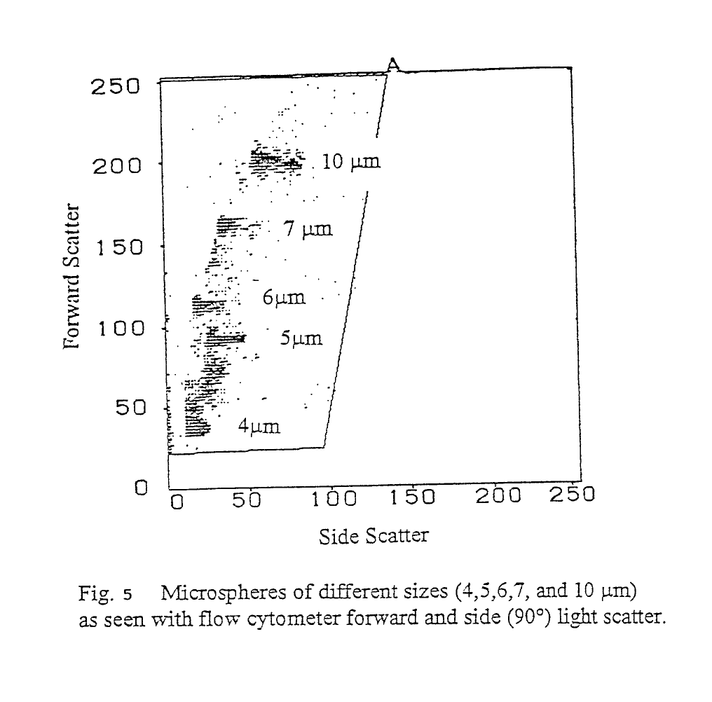

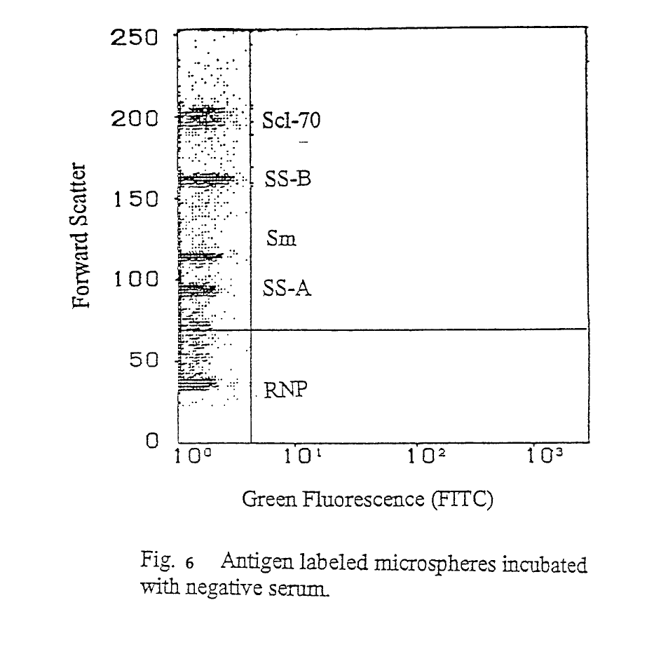

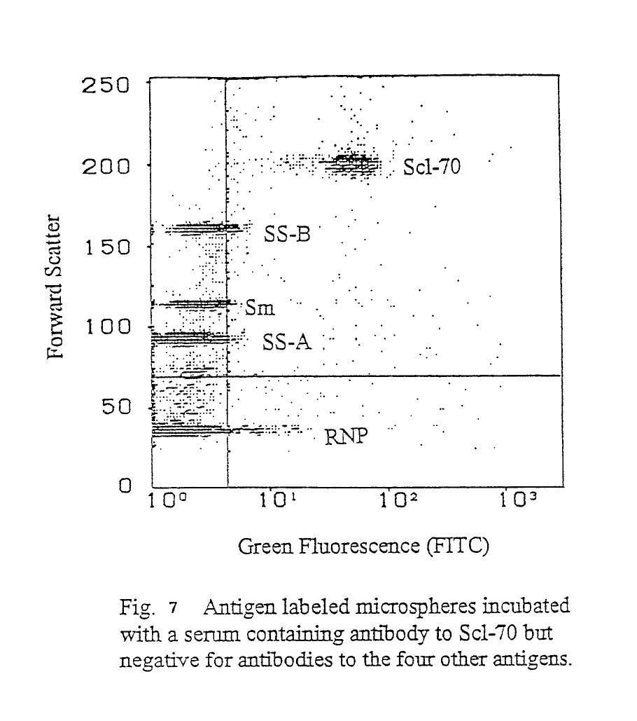

It has been demonstrated that the antigens, RNP/Sm, SM, SSA- SSB, dsDNA and Scl-70, can be attached to latex beads of the following sizes, 4, 5, 6, 7, 3 and 8 μm, respectively (FIG. 5). After incubation with sera from patients with antibodies to these antigens, followed by the addition of fluorescenated anti-human IgG, beads that have bound antibody fluorescence and are specifically detectable because of their size differences (FIGS. 1, 2, 6 and 7).

The results of the assays of the present invention are improved by determining: 1) optimal concentrations of antigens on latex microspheres using block titration methods; 2) optimal ratios of serum to bead concentrations; and 3) optimal concentrations of secondary antibody (anti- human IgG). Once optimal antigen-bead-antibody concentrations are determined and, using commercially available human sera containing these antibodies, antigen coated beads are incubated with various dilutions of sera and secondary (detector) antibody. Several dilutions of known positive sera are performed to determine the sensitivity of the assay.

### Example 6

Multiple Parameter Detection System

In accordance with another embodiment of the present invention, highly purified RNP, Sm, SS-A, SS-B, dsDNA and Scl-70 antigens are bound to 4, 5, 6, 7, 8 and 3 μm latex beads, respectively and stabilized for extended shelf life. Diluted patient serum is placed into test tubes containing a mixture of the six antigen coated beads and incubated. If an antibody is present for a specific antigen, it will bind to that specific bead. A second incubation with goat anti-human IgG, conjugated with fluoresceine isothiocyanate (FITC), is carried out. This conjugate will bind immunologically to the anti-antigen IgG of the antigen-antibody complex, forming a “sandwich” consisting of bead—antigen—1° antibody—2° antibody—FITC (FIG. 1).

The fluorescence intensity is based on the avidity of the bead/antibody/conjugate binding. The samples are analyzed using flow cytometers having laser excitation wavelengths of 488 nm. Emission wavelengths are detected by photomultipliers which convert the fluorescent analog signals into two parameter histograms expressing forward light scatter (Y-axis) versus fluorescence intensity (X-axis, FIG. 2).

Procedure

1. Determine which antigen coating buffer (either carbonate buffer or phosphate buffered saline, PBS) yields highest binding capacity to latex beads. Optimal concentration of beads needs to be determined in order for the flow cytometer to count accurately.

2. Establish titers of both antibody against the coated beads and run several experiments to maximize signals obtained at different antigen concentrations (mean channel fluorescence).

3. Incubate antigen/serum mixture for several minutes (time to be determined) and wash with either carbonate buffer or PBS.

4. Wash antigen coated beads in buffer.

5. Determine the background of unlabelled beads.

6. If background exists, decrease to near baseline values.

7. Find proper dilution of patient and control sera and add to coated beads.

8. Incubate for optimal time (to be determined and wash with buffer (PBS or carbonate buffer).

9. Determine the optimum amount of a labeled goat-anti-human f(ab′)² antibody by titration and use as the indicator system.

10. Repeat step 8.

11. Read on flow cytometer.

Quality Control

Negative and positive controls are included in each assay. During development all patient samples are tested in parallel by a conventional ELISA method. Reagents are used only during established shelf-lives.

Limitations

Hemolyzed or lipemic samples may affect assay.

Human Subjects

Sera previously obtained for other purposes and frozen as archival material.

### Example 7

Multiple Parameter Detection System

In accordance with one embodiment of the present invention highly purified RNP, Sm, SS-A, SS-B and Scl-70 and dsDNA antigens are bound to 1, 15, 25, 50, 75 and 100 μm latex beads, respectively and stabilized for extended shelf life. Diluted patient serum is placed into test tubes containing a mixture of the six antigen coated beads and incubated. If an antibody is present for a specific antigen, it will bind to that specific bead. A second incubation with anti-human IgG, conjugated with fluorescein isothiocyanate (FITC), is carried out. This conjugate will bind immunologically to the anti-antigen IgG of the antigen-antibody complex, forming a “sandwich” consisting of bead—antigen 1° antibody—2° antibody—Conjugate (FIG. 1).

The fluorescence intensity is based on the avidity of the bead/antibody/conjugate binding. The samples are analyzed using flow cytometers having laser excitation wavelengths of 488 nm. Emission wavelengths are detected by photomultipliers which convert the fluorescent analog signals into at least two parameter histograms expressing forward light scatter (Y-axis) versus fluorescence intensity (X-axis FIG. 2).

Procedure:

1. Determine which antigen coating buffer (either carbonate buffer or phosphate buffered saline, PBS) yields highest binding capacity to latex beads. Optimal counts for beads need to be determined in order for the flow cytometer to count accurately.

2. Establish titers of both antibody against the coated beads and run several experiments to maximize signals obtained at different antigen concentrations (mean channel fluorescence).

3. Incubate antigen/serum mixture for several minutes (time to be determined) and wash with either carbonate buffer or PBS.

4. Wash antigen coated beads in buffer (PBS or 0.5% Tween 20 in PBS or carbonate buffer).

5. Determine the background of unlabelled beads.

6. If background exists, decrease to rear baseline values.

7. Find proper dilution of patient and control sera and add to coated beads.

8. Incubate for optimal time (to be determined) and wash with buffer (PBS or carbonate buffer).

9. Determine the optimum amount of a labeled anti-human antibody by titration and use as the indicator system.

10. Repeat step 8.

11. Read on flow cytometer.

Quality Control

Negative and positive controls should be included in each assay. During development all patient samples should be tested in parallel by a conventional ELISA method. Reagents should be used only during established shelf-lives.

Limitations

Hemolyzed or lipemic samples may affect assay.

Human Subjects

Sera may be previously obtained and frozen as archival material.

In accordance with another embodiment of the present invention, a “no wash” immunoassay, immunobead-flow cytometry highly purified Scl-70, RNP, Sm, SS-A, SS-B, and dsDNA antigens are bound to 3, 4, 5, 6, 7 and 8 μm latex beads, respectively and stabilized for extended shelf life. Diluted patient serum is placed into test tubes containing a mixture of six antigen coated beads and incubated. If an antibody is present for a specific antigen, it will bind to that specific bead. Next, a dilution of goat anti-human IgG-FITC in albumin in PBS is added and a second incubation is carried out. This conjugate will bind immunologically to the anti-antigen IgG of the antigen-antibody complex, forming a “sandwich” consisting of bead—antigen—1° antibody—2° antibody—FITC (FIG. 1). Then PBS is added and the samples are analyzed on a flow cytometer.

In a variation of this example, viral or bacterial antigens or antibodies may be used in no wash, one step procedure.

### Example 8

### One Step Bead Detection System

No Wash Detection System

The following “no wash” procedure is a modification of the above bead evaluation method and utilizes a protein/buffer step in the conjugate dilution to eliminate non-specific staining resulting from increased patient serum protein concentrations.

1. Allow reagents to come to room temperature.

2. Gently invert antigen coated bead mixture until an even distribution of bead product is observed.

3. Label test tubes for Blank, Controls, and Patients.

4. Add 600 μL of multiple bead suspension to each tube.

5. Dilute patient and control serum 1:100 in buffer solution with protein.

6. Add 15 μL of diluted serum to appropriate test tubes.

7. Gently vortex and incubate for 15 to 30 minutes at room temperature.

8. Make a 1:20 dilution of goat anti-human F(ab′)² IgG FITC (or other fluorochrome) in buffer with protein.

9. Add 50 μL of diluted conjugate to each tube.

10. Gently vortex and incubate for 15 to 30 minutes at room temperature, in the dark.

11. Analyze on flow cytometer.

### Example 9

No Wash Detection System—Pre-mixed Bead Suspension

1. Gently invert or vortex antigen coated bead mixture until an even distribution of bead product is observed.

2. Label test tubes for Controls and Patients.

3. Add at least 200 μL of bead suspension to each tube.

4. Dilute patient and control serum at least 1:100 in buffer with protein (e.g. 10 μL serum to 990 μL buffer).

5. Add at least 10 μL of diluted serum to appropriate test tubes.

6. Gently vortex and incubate for at least 5 minutes at room temperature.

7. Make an at least 1:2 dilution of labeled anti-human antibodies in at least buffer/protein solution.

8. Add at least 10 μL of diluted conjugate to each tube.

9. Gently vortex and incubate for at least 5 minutes at room temperature, in the dark.

10. Analyze on flow cytometer.

### Example 10

No Wash Detection System—Individual Bead Suspension

1. Allow reagents to come to room temperature.

2. Gently invert or vortex antigen coated bead mixture until an even distribution of bead product is observed.

3. Label test tubes for Controls and Patients.

4. Add equal quantities of bead suspension to each tube.

5. Pre-dilute patient and control serum to about 1:100 in buffer with protein (e.g. 10 μL serum to 990 μL buffer).

6. Add equal quantities of diluted serum to appropriate test tubes.

7. Gently vortex and incubate at room temperature.

8. Make at least a 1:5 dilution of labeled anti-human antibody in a buffer/protein solution.

9. Add equal quantities of diluted conjugate to each tube.

10. Gently vortex and incubate at room temperature.

11. Analyze on flow cytometer.

### Example 11

Anti-sle Screening Assay Test Kit

In accordance with still another embodiment of the present invention, an FIBA-FCM assay test kit is described as follows.

Summary of Procedure

1. Add 15 μL of a prediluted sample to 600 μL of RNP, Sm, SS-A(Ro), SS-B(La), dsDNA and Scl-70 coated bead solution. Mix well.

2. Incubate at room temperature for 15 minutes.

3. Place one drop (5 uL) of fluorescenated conjugate into each tube. Mix well.

4. Incubate at room temperature, in the dark, for 15 minutes.

5. Read on flow cytometer.

Intended Use of Kit.

For the simultaneous detection of anti-antibodies to the antigens RNP, Sm, SS-A(Ro), SS-B(La), dsDNA and Scl-70 in serum as an aid in the diagnosis and of certain so-called rheumatic or connective tissue diseases, e.g. systemic lupus erythematosis (SLE), Sjoghren's syndrome, scleroderma, and polymyositis. For in vitro diagnostic use.

Summary and Explanation

Current approaches to the detection of auto-antibodies in these diseases are through the use of ELISA or immunodiffusion assays. The above flow cytometry method shortens turnaround times, decreases technical manipulations, increases sensitivity, eliminates the use of multiple plates, and decreases laboratory costs.

The above assay is a flow cytometric based procedure intended for the semi-quantitation of antibodies to RNP, Sm, SS-A (Ro), SS-B(La), dsDNA and Scl-70. The results are reported in a semi-quantitative fashion using linear fluorescence scales derived from the flow cytometers themselves. Gradations are strictly standardized against positive controls.

Principle and Procedure Highly purified RNP, Sm, SS-A, SS-B, dsDNA and Scl-70 antigen are bound to respective 4, 5, 6, 7, 8 and 3 μm latex beads and stabilized for extended shelf life Diluted patient's sera are placed into test tubes containing a mixture of the six antigen coated beads and incubated. If an antibody is present to the specific antigen (i.e bead), it will bind to that specific bead. A second incubation with goat anti-human IgG conjugated with fluorescein isothiocyanate (FITC) is carried out. Conjugate will bind immunologically to the anti-antigen IgG of the antigen-antibody complex, forming a “sandwich” (FIG. 1).

The fluorescence intensity is based on the avidity of the bead/antibody/conjugate binding. The samples are analyzed using flow cytometers having laser excitation wavelengths of 488 nm. Emission wavelengths of 514 nm are detected by photomultipliers which convert the fluorescent analog signals into digital signals two parameter histograms (size [Y-axis]) versus fluorescent intensity (X-axis, FIG. 2).

These reagents should be stored at 2-8° C. Do not allow these reagents to contact the skin or eyes. If contact occurs, wash with copious amounts of water.

Specimen Collection

Whole blood (at least 0.4 mL) should be collected in a non-anticoagulated, red top tube by accepted medical techniques. The serum is separated from the clot and refrigerated, 2-8° C., for short-term storage or stored frozen, −20° C., for long-term storage. Avoid multiple freeze-thaw cycles. Specimens containing visible particulate matter should be clarified by ultracentrion before testing. Grossly contaminated specimens should not be used.

Caution: Serum samples should not be heat-inactivated as this may cause false positive results.

Detailed Procedure

Allow patient samples to warm to room temperatures. Return promptly to refrigerator after use.

1. Properly label sufficient numbers of test tubes to identify positive and negative controls and patient samples.

2. Add 600 μL of a solution containing each bead suspension into each of the labeled test tubes.

3. Prepare 1:100 dilutions of the Positive and Negative Controls, and the patient samples, by adding 10 μL of each to 990 μL of sample diluent.

4. Mix sample dilutions gently by withdrawing and expelling in a pipette tip 2 or 3 times or vortexing.

5. Transfer 15 μL of each diluted control or patient sample into corresponding test tube.

6. Gently vortex and incubate at room temperature (20 to 30° C.) for at least 15 minutes.

7. Add one drop (50 μL) of fluorescenated conjugate to each tube.

8. Gently vortex and incubate for 15 minutes at room temperature in the dark.

9. Analyze on flow cytometer.

Note: Analysis should be made within 2 hours of final staining.

Calculation of Results

The evaluation of specimens is based on a semi-quantitation of the fluorescent intensity. Gradations are directly related to the linear scale and used on the FL1 x-axis. Samples may therefore be gated by two-parameter settings (e.g. forward angle light scatter and LFL 1) to eliminate sample background.

Adjustment of the FL1 PMT to a specific mean channel fluorescence on the “smallest” size bead, stained with the “normal” or negative control, will standardize instrument settings. Patient results may be semi-quantitate using the mean channel fluorescence of each bead stained with patient or positive control divided by the mean channel fluorescence of the “normal” or negative control.

Patient samples which contain very high levels of antibody may give fluorescent results greater than the linear scale and demonstrate high fluorescent index values. If a more accurate semi-quantitative unit is necessary, dilute the patient sample using Sample Diluent, reassay, and report the result (index) while indicating the dilution factor.

Calibration

The assay reagents should be adjusted for optimal concentrations for the flow cytometers mentioned before. The positive control must fall within the ranges established for that lot. Slight variations in intensity may arise depending on a labs preference for gain and detector settings.

The beads should be evaluated for sensitivity against ELISA assays using known positives quantitate to international standards (EU/mL).

Limitations

The results of the present assay kit should be used in conjunction with clinical criteria for diagnosis of autoimmune rheumatic disease. While laboratory tests should not be used as dictators of therapy, the can be used to supplement clinical observations and as guides to therapy.

Beads sizes may run from about 0.25 μm to 740.0 μm.

Other bead materials may include, polystyrene, glass, beads coated with different radical groups, metacrylate-styrene latex, traditional latex, polystyrene DVB. Possible fluorochromes, whether used on undetected antibodies or impregnated into bead material, may include: Fluoresceine isothiocyanate (FITC), Phycoerythrin (PE), Peridinin, Allochlorophyll (Per CP), Allophycocyanin, CY5, Texas Red, Propidium iodide, Ethidium bromide, and Acridine orange.

Antibodies which may be attached to beads or probes to detect antigens in body fluids include any monoclonal antibodies directed at infectious antigens such as, viruses, bacteria, parasites, fungi, and mycoplasma; autoantigens—(cell and cell components, such as nuclei, DNA, RNA nucleoli, membranes); cell products, such as collagen, reticulin, mucus, hormones, cytokines, neurotransmitters, coagulation factors, complement factors, mediators of inflammation (e.g. vasoconstructive, chematoctic, enzymatic, phospholy), and enzymes; cell membrane antigens (erythrocytes-cross match, HLA-transplantation), and spermatozoa.

DNA or RNA may be attached to beads as molecular probes for the detection of infectious agents, particularly viruses (EBV, CMV, HIV, varicella-zoster, hepatitis, HPV, HCV, HBV, HTLV), oncogens and other disease related genes, in fluids by molecular hybridization.

Antibodies may also be attached for detection of antigens in body fluids.

Many of the flow cytometers now have autobiosamplers which utilize robotic arms for multiple sampling. Likewise, the entire procedure may be placed on automated pipettors/dilutors prior to the actual analysis for large scale operations.

Semi-quantitative results can now be achieved by correlating the relative fluorescence to that of a linear histogram where the mean flourescent channels of each bead, based on a “normal” or negative control, are divided into the mean of the patient or positive control for the corresponding sized bead. This is the same for any instrument used. Quantitative results may also be obtained by using pre-analyzed standards at specific EU/mL concentration.

Other examples of materials bound on beads:

a) Antigens—RnP, SM, SS-A, SS-B, Scl-70

b) Antibodies—anti-p24, anti-HTLV, OKT3

c) Chemicals—IL-2, Toxins, drugs

d) Microorganisms—E-coli, HTLV, viruses

e) Cell components—IL-2R, Glycoproteins

f) DNA—double stranded complement strands

g) RNA—viral RNA

h) Others—cardiolipin, pollen, metals, recombinant products.

### Example 12

Anti-viral Screening Assay and Test Kit—No Wash

In accordance with still another embodiment of the present invention, an FIBA-FCM assay test kit is described as follows:

Summary of Procedure

1. Add 15 μL of sample to 600 μL of CMV, EBV, HbsAg, Hbc, HTLV, HCV, HIV bead solution. Mix well.

2. Incubate at room temperature.

3. Place one drop of fluorescenated conjugate into each tube. Mix well.

4. Incubate at room temperature, in the dark.

5. Read on flow cytometer.

For the simultaneous detection of anti-antibodies to the antigens CMV, EBV, HbsAg, HBC, HIV, HTLV, HCV, in serum as an aid in the diagnosis of viral infection.

Summary of Explanation

Current approaches to the detection of auto-antibodies in these diseases are through the use of ELISA or immunodiffusion assays. The above flow cytometry method shortens turnaround times, decreases technical manipulations, increases sensitivity, eliminates the use of multiple plates, and decreases laboratory costs.

The above assay is a flow cytometric based procedure intended for the semi-quantitation of antibodies to HbsAg, HBC, EBV, HTLV, HCV, and HIV. The results are reported in a semi-quantitative fashion using log fluorescence scales derived from the flow cytometers themselves. Gradations are strictly standardized against positive controls. Principle and Procedure

Highly purified CMV, EBV, HIV, HCV, HbsAg, HBC, and HTLV antigens are bound to respective 2, 3, 4, 5, 6, 7 and 10 μm latex beads and stabilized for extended shelf life. Diluted patient's sera are placed into test tubes containing a mixture of the seven antigen coated beads and incubated. If an antibody is present to the specific antigen (i.e. bead), it will bind to that specific bead. After washing the bead/sera mixture to remove residual sample, a second incubation with goat anti-human IgG conjugated with fluorescein isothiocyanate (FITC) is carried out. Conjugate will bind immunologically to the anti-antigen IgG of the antigen-antibody complex, forming a “sandwich” (FIG. 1).

The fluorescence intensity is based on the avidity of the bead/antibody/conjugate binding. The samples are analyzed using flow cytometers having laser excitation wavelengths of 488 nm. Emission wavelengths are detected by photomultipliers which convert the fluorescent analog signals into digital signals two parameter histograms (size [Y-axis]) versus fluorescent intensity (X-axis).

Detailed Procedure

Return promptly to refrigerator after use.

1. Properly label sufficient numbers of test tubes to identify positive and negative controls and patient samples.

2. Add 100 μL×number of antibodies tested (e.g. 4 antibodies=4×100 uL or 400 uL) of bead solution into each of the labeled test tubes.

3. Prepare proper dilutions of the positive and negative controls, and the patient samples.

4. Mix sample dilutions gently by withdrawing and expelling in a pipette tip 2 to 3 times or by vortexing.

5. Transfer a volume of each diluted control or patient sample into corresponding test tube.

6. Gently vortex and incubate at room temperature (20-30° C.) for 15 minutes.

7. Add one drop (approx. 50 μL) of fluorescenated conjugate to each tube.

8. Gently vortex and incubate for 15 minutes at room temperature in the dark.

9. Analyze on flow cytometer.

NOTE. Analysis should he made within 2 hours of final staining

### Example 13

Multiple Fluorescence Bead Assay

1. Determine the amount of latex bead suspension (e.g. # of drop w/mL carbonate buffer) needed to achieve an event count of 900-1000 beads/second on the flow cytometer.

2. Titer antigen (Ag) to appropriate 1 μg/mL and use concentration deemed optimal for maximum mean channel and fluorescence.

3. Add antigen to each respective tube: (μg)

| Antigen (size bead) | Drops/mL Buffer | Ag/mL Buffer |
|---|---|---|
| Scl-70 (3 μm, PE) | 10 | 10 |
| RNP (4 μm, FITC) | 3 | 30 |
| Sm (5 μm, FITC) | 3 | 10 |
| SS-A (6 μm, FITC) | 6 | 15 |
| SS-B (7 μm, PE) | 6 | 15 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of carbonate buffer per original milliliters of antigen/bead solution may be diluted if data indicates that this does not interfere with end result).

8. Add 100 mL of each antigen/bead mixture to all reaction tubes.

9. Dilute positive, negative and patient serum 1:100 in protein buffer.

10. Add 15 μL of each serum diluted to appropriately labeled tube.

11. Vortex gently and incubate for 15 minutes at room temperature.

12. Add 50 μL of Goat anti-human IgG F(ab′)²-FITC 1:20 (NOTE: dilution may slightly vary from lot to lot. Titer all new lots).

13. Gently vortex and incubate 15 minutes at room temperature.

14. Centrifuge, decant and gently resuspend beads.

Viral and/or bacterial antigens using human IgG FITC and human IgM PE for acute versus convalescent infections may be used.

### Example 14

Multiple Impregnated Dye Bead Assay—No Wash

1. Determine the amount of latex bead suspension (e.g. # of drop w/mL carbonate buffer) needed to achieve an event count of 900-100 beads/second on the flow cytometer.

2. Titer antigen (Ag) to appropriate μg/mL and use concentration deemed optimal for maximum mean channel and fluorescence.

3. Add a particular antigen to each respective tube (μg)

| Antigen (size bead/ | | |
|---|---|---|
| impregnated dye) | Drops/mL Buffer | Ag/mL Buffer |
| 4 μm, PE | 3 | 30 |
| 5 μm, PE | 3 | 10 |
| 6 μm, PE | 6 | 15 |
| 7 μm, FITC | 6 | 15 |
| 10 μm, FITC | 10 | 10 |
| 12 μm, FITC | 10 | 10 |

4. Incubate bead/antigen mixture for 12-18 hours at 4-8° C.

5. Centrifuge solution at full speed in a refrigerated centrifuge for 10 minutes.

6. Decant supernatant and gently resuspend beads by hand.

7. Add 1 mL of carbonate buffer per original milliliters of antigen/bead solution.

8. Add 100 uL of each antigen/bead mixture to all reaction tubes.

9. Dilute positive, negative and patient serum protein buffer.

10. Add appropriate of each serum diluted to appropriately labeled tube.

11. Vortex gently and incubate for 15 minutes at room temperature.

12. Add appropriate amount of Goat anti-human IgG F(ab′)²-FITC 1:20 (NOTE: dilution may slightly vary from lot to lot. Titer all new lots.

13. Gently vortex and incubate 15 minutes at room temperature.

14. Read on flow cytometer.

### Example 15

Antibody Control Material

New antibodies are produced (for example, against anti-CD34 antigen for stem cell transplantation monitoring) which the investigator has no way of testing the antibody for specificity, sensitivity, or purity to the specific epitope. Because the CD34 antigen only occurs in less than 2% of the normal bone marrow population, this evaluation would be very difficult to perform.

The invention would coat one size bead with a recombinant CD34 antigen (recombinator purified).

1. Label several tubes with the quantities of 1, 5, 10, 15 and 20 uL for quantity of CD34 antibody to be added.

2. Add 100 uL of CD34 antigen coated beads to each of the above tubes.

3. Add 1, 5, 10, 15, and 20 uL of anti-CD34 Antigen antibody to each of the appropriately labeled antibody tubes.

4. Gently vortex and incubate for 15 minutes at room temperature.

5. Add 1 mL of phosphate buffered saline (PBS) and centrifuge.

6. Decant and gently vortex.

7. Unless previously conjugated, add conjugated fluorescenated goat anti-species antibody to each of the antibody labeled tubes.

8. Gently vortex and incubate for 15 minutes in the dark, at room temperature.

9. Repeat steps 5 and 6.

10. Add 1 mL of PBS, vortex.

11. Read on flow cytometer using forward scatter versus FL 1 channel or Forward versus side scatter and gate around the beads. Read gated material and transfer information to a single parameter fluorescent histogram.

12. Use a negative, non-anti-CD34 antibody as a control for adjustment of any fluorescent mean channel settings.

In the various examples, as appropriate, modularities may be changes depending on the particular circumstances, the context, and the types of target chemical being tested. Thus, the assay may use only one of the indicated beads, or two only beads, or any other variation to create a mixture of the desired coated beads.

Further, various viral and/or bacterial antigens or antibodies may be used in desired combinations. In this way, the invention provides the ability mix and match assays (beads) in a single tube with a chart indicating the proper amount of bead and conjugate required for use with a pre-established amount of patient/control serum.

The present invention provides a highly effective improved assay, kit and system, by which the principal objective, among others, is completely fulfilled. It is contemplated, and will be apparent to those skilled in the art from the preceding description and accompanying drawings, that modifications and/or changes may be made in the illustrative embodiments without departing from the present invention. Accordingly, it is expressly intended that the foregoing description and accompanying drawings are illustrative of preferred embodiments only, not limiting, and the invention be determined by reference to the appended claims.

1. An immunobead-flow cytometry assay for simultaneously detecting a plurality of antigens or antibodies in a sample comprising the steps of:
coating a plurality of distinct latex beads each with at least one of a unique antigen or antibody,
incubating the coated beads with serum,
labeling the bead/serum mixture with anti-human fluorescently labeled antibodies,
analyzing the labeled beads on a flow cytometer with at lease one of a blank and isotopic control as the negative standard, and forward scatter versus fluorescence used to detect positivity.

2. An assay as claimed in claim 1 further comprising the steps of:
binding one of highly purified Scl-70, RNP, SM, SS-A, SS-B and dsDNA antigens to one of 3, 4, 5, 6, 7 and 8 μm latex beads,
placing diluted patient serum into test tubes containing a mixture of the six antigen coated beads,
incubating the serum and beads so that any antibody for a specific antigen will bind to that specific bead,
incubating the beads with goat-anti-human IgG conjugated with a fluorochrome such as fluorescein isothiocyanate (FITC), to allow the conjugate to bind immunologically to the anti-antigen IgG of the antigen-antibody complex, forming a “sandwich” consisting of bead—antigen—1° antibody—2° antibody—FITC,
analyzing the sandwich using a flow cytometer having a laser excitation wavelength of about 488 nm and producing emission wavelengths detected by photomultipliers, and
converting the fluorescent analog signals into at least two parameter histogram expressing forward light scatter (Y-axis) versus fluorescence intensity (X-axis) and analyzed quantitate or semi-quantitate on linear fluorescent (X-axis) only.

3. An assay as claimed in claim 1 further comprising:
a. determining which antigen coating buffer of carbonate buffer and phosphate buffered saline yields highest binding capacity to latex beads,
b. establishing titers of both antibodies against the coated beads and running several experiments to maximize signals obtained at different antigen concentrations (mean channel fluorescence),
c. incubating the antigen/serum mixture for several minutes and washing with either carbonate buffer or phosphate buffered saline,
d. washing antigen coated beads in a buffer of at least one of phosphate buffered saline, 0.3% protein in phosphate buffered saline, or carbonate buffer,
e. determining the background of unlabelled beads,
f. if background exists, decreasing to near baseline values,
g. finding proper dilution of patient and control sera and adding to coated beads,
h. incubating for optimal time and washing with buffer of phosphate buffered saline and carbonate buffer.
i. determining the optimum amount of labeled goat-anti-human f(ab′)² antibody by titration and using as the indicator system,
j. repeating step h,
k. adding 1 mL of buffer of phosphate buffered saline and carbonate buffer, and
l. reading on flow cytometer.

4. An assay as claimed in claim 1 comprising the steps of
a) coating each of a plurality of discrete beads with a particular antigen or antibody using a buffer,
b) incubating bead/serum mixture for several minutes and washing with at least one of carbonate buffer and phosphate buffered saline,
c) washing incubated beads in buffer,
d) determining the background of unlabelled beads,
e) if background exists, decreasing to near baseline values,
f) finding proper dilution of patient and control sera and adding to coated beads,
g) incubating for optimal time,
h) determining the optimum amount of a labeled anti-human antibody by titration and using as the indicator system,
i) repeating step g), and
j) reading on flow cytometer.

5. An assay as claimed in claim 1 using an anti-viral screening kit for simultaneous detection of anti-antibodies to antigens selected from one or more of the following: HTLV, HCV, EBV, HIV, CMV HbsAg, Hbc in serum, Hepatitis Surface antigen, core antigen, HIVI/I, HTL VI/II, and Hepatitis C antigen, as an aid in the diagnosis of viral infection, the kit comprising the steps of:
a) allowing test components and patient samples to warm to room temperature before use, returning promptly to refrigerator after use,
b) properly labeling sufficient numbers of test tubes to identify positive and negative controls and patient samples,
c) adding a specific amount of bead solution into each of the labeled test tubes,
d) preparing dilutions of the Positive and Negative Controls, and the patient samples,
e) mixing sample dilutions gently by withdrawing and expelling in a pipette or vortexing,
f) transferring an amount of each diluted control or patient sample into corresponding test tube,
g) gently vortexing and incubating at room temperature (20-30° C.) for 15 to 30 minutes,
h) adding one drop (50 μL) of fluorescenated conjugate to each tube,
i) gently vortexing and incubating for 15 to 30 minutes at room temperature in the dark, and
j) analyzing on flow cytometer.

6. A fluorescent immuno-bead assay kit for use in conjunction with flow-cytometry for the simultaneous detection of one or more of the antinuclear antibodies to RNP (ribonucleoprotein) seen in mixed connective disease, systemic lupus erythematosis (SLE), Sjogren's syndrome, scleroderma and polymyositis; Sm (Smith antigen) in SLE; SS-A in Sjogren's syndrome and SLE; SS-B in Sjogren's syndrome and SLE; dsDNA in SLE; and Scl-70 in scleroderma, these antibodies being commonly encountered in the so-called rheumatic diseases, the kit comprising:
(a) at least one particle sized latex bead having sizes selected from 3 μm, 4 μm, 5 μm, 6 μm, 7 μm, and 8 μm,
(b) at least two antigens selected from Sm/RNP Complex antigen, Sm antigen, SS-A (Ro) antigen, SS-B (La) antigen, Scl-70 antigen, dsDNA antigen,
(c) at least two anti-antigen selected from Anti-RNP, Anti-Sm, Anti-SS-A (Ro), Anti-Sm, Anti-SSB (La), Anti-Scl-70, anti-dsDNA,
(d) Goat anti-human IgG F(ab′)²-FITC,
(e) Sodium Carbonate,
(f) Sodium Bicarbonate, and
(g) Albumin, bovine,
whereby beads, antigen and anti-antigen are selected for use in the kit based on target antigens or antibodies being tested.

7. An assay kit as claimed in claim 6 wherein beads with antigens coated on the surface are impregnated with dye and assayed by size and/or fluorescent properties.

8. An assay as claimed in claim 6 wherein antigens are grouped in predetermined combinations.

9. An assay kit as claimed in claim 6 designed to simultaneously detect several antinuclear antibodies in patient sera utilizing antigen coated microspheres to different sizes, binding of antibody to spheres is detected by FITC labeled anti-human IgG and flow cytometry, with each individual antibody detected because of binding to a different sized sphere which is determined by light scatter, the kit comprising at least one antigen coated bead selected from:
a) 3 μm latex beads coated with Scl-70 antigen,
b) 4 μm latex beads coated with Sm/RNP complex antigen,
c) 5 μm latex beads coated with Sm antigen,
d) 6 μm latex beads coated with SS-A (Ro) antigen,
e) 7 μm latex beads coated with SS-B (La) antigen, and
f) 8 μm latex beads coated with dsDNA antigen.

10. An assay as claimed in claim 6 for anti-SLE screening for the simultaneous detection of anti-antibodies to the antigens RNP, Sm, SS-A (Ro), SS-B (La), dsDNA and Scl-70 in serum as an aid in the diagnosis of certain co-called rheumatic or connective tissue diseases, such as systemic lupus erythematosis (SLE), Sjogren's syndrome, scleroderma, and polymyositis, the assay comprising the steps of:
a) adding 15 μL of sample to 600 μL of RNP, Sm, SS-A (RO), SS-B (La), dsDNA and Scl-70 coated bead solution, and mixing well,
b) incubating at room temperature for 15 to 30 minutes,
c) placing one drop of fluorescenated conjugate into each tube, mixing well,
d) incubating at room temperature, in the dark, for 15 to 30 minutes, and
e) reading of flow cytometer.

11. An assay as claimed in claim 6 for anti-viral screening for the simultaneous detection of anti-antibodies to antigens selected from one or more of: HTLV, HCV, EBV, HIV, CMV HbsAg, Hbc in serum, Hepatitis Surface antigen, core antigen, HIVI/I, HTL VI/II, and Hepatitis C antigen, as an aid in the diagnosis of viral infection, the assay comprising the steps of:
a) adding an appropriate amount of sample to a bead solution including one or more antigens selected from CMV, EBV, HbsAg, Hbc, HTLV, HCV, HIV and mixing well,
b) incubating at room temperature for 15 minutes,
c) placing one drop of fluorescenated conjugate into each tube, mixing well,
d) incubating at room temperature, in the dark, for 15 to 30 minutes, and
e) reading of flow cytometer.

12. A no-wash fluorescent immunobead assay comprising the steps of:
a) allowing reagents to come to room temperature,
b) gently inverting antigen coated bead mixture until an even distribution of bead product is observed,
c) labeling test tubes for controls and patients,
d) adding multiple bead suspension to each tube,
e) diluting patient and control serum 1:100 in protein buffer,
f) adding 15 μL of diluted serum to appropriate test tubes,
g) gently vortexing and incubating for 15 minutes at room temperature,
h) making a dilution of goat anti-human F(ab′)² IgG FITC in protein buffer,
i) adding 50 μL of diluted conjugate to each tube,
j) gently vortexing and incubating for 15 minutes at room temperature, in the dark, and
k) analyzing on flow cytometer.

13. A no-wash detection method using the assay of claim 1, the method comprising the steps of:
a) coating each of the plurality of discrete beads with a particular probe,
b) gently inverting the probe coated bead mixture until an even distribution of bead product is observed,
c) labeling test tubes for Blank, Controls, and Patients,
d) adding equal quantities of bead suspension to each tube,
e) diluting patient control serum to a specific volume with protein buffer,
f) adding equal quantities of diluted serum to appropriate test tubes,
g) gently vortexing and incubating at room temperature,
h) making a dilution of labeled anti-human antibody in protein buffer,
i) adding equal quantities of diluted conjugate to each tube,
j) gently vortexing and incubating at room temperature, and
k) analyzing on flow cytometer.

14. The method as claimed in claim 13 wherein the probe is selected from at least one of:
a) antigens selected from one or more of RnP, Sm, SS-A, SS-B, Scl-70, dsDNA, Jo-1, centromeres, histones or other antigens related to rheumatic diseases, viruses, bacteria or cellular material,
b) antibodies selected from one or more of anti-p24, anti-HTLV, OKT3,
c) chemicals selected from one or more of IL-2, toxins, drugs,
d) microorganisms selected from one or more of E. coli, HTLV, viruses, other bacteria
e) cell components selected from one or more of IL-2R, Glycoproteins,
f) DNA—double stranded complement strands,
g) RNA—viral RNA, and
h) cariolipin, pollen, metals, or recombinant proteins.

15. A no-wash assay comprising the steps of:
a) washing beads,
b) coating beads,
c) suspending coated beads,
d) mixing different beads,
e) reacting beads,
f) reacting beads with anti-human FITC labeled antibodies, and
g) reading beads on flow cytometer.
